(19) United States
(12) Patent Application Publication
(10) Pub. No.: US 2016/0140225 A1
(43) Pub. Date: May 19, 2016

(54) MUSIC RECOMMENDATION SYSTEM OF VEHICLE AND METHOD THEREOF

(71) Applicant: HYUNDAI MOTOR COMPANY, Seoul (KR)

(72) Inventors: Woochul Jung, Seoul (KR); Young Woo Choi, Incheon (KR)

(21) Appl. No.: 14/722,716

(22) Filed: May 27, 2015

(30) Foreign Application Priority Data
Nov. 14, 2014 (KR) 10-2014-0158825

(51) Int. Cl. G06F 17/30; G06F 3/16

(52) U.S. Cl. CPC G06F 17/30761; G06F 3/165; G06F 17/30752; G06F 17/30772

(57) ABSTRACT

A music recommendation system of a vehicle includes: a sound source analysis unit that analyzes music characteristic information of a plurality of sound source files, respectively, generates a matching table including pieces of music metadata based on the analyzed music characteristic information of the plurality of sound source files, analyzes music characteristic information of a plurality of sound source files, respectively, included in a music list played by a driver of the vehicle, and generates an analysis table based on the analyzed music characteristic information of the plurality of sound source files included in the music list; an input unit that receives a music recommendation request from the driver; and a sound source recommending unit that extracts music characteristic information from the matching table similar to music characteristic information in the analysis table and generates a recommendation list based on the extracted music characteristic information.

### CROSS-REFERENCE TO RELATED APPLICATION

This application claims priority to and the benefit of Korean Patent Application No. 10-2014-0158825 filed in the Korean Intellectual Property Office on Nov. 14, 2014, the entire contents of which are incorporated herein by reference.

### BACKGROUND OF THE DISCLOSURE

(a) Technical Field

The present disclosure relates generally to a music recommendation system of a vehicle, and more particularly, to a music recommendation system of a vehicle capable of recommending music to a driver by analyzing a physical characteristic, and a method thereof.

(b) Description of the Related Art

In recent years, various devices for enhancing the convenience of passengers staying inside their respective vehicle for extended periods of time (e.g., due to traffic) have been installed inside vehicles. For example, the devices for enhancing the convenience of passengers may include an audio system. The audio system may include an external sound terminal to connect to a portable audio device such as a portable cassette, a CD player, an MP3 player, and a mobile communication device. The vehicle can connect the portable audio device to the car audio system (e.g., through the portable sound terminal or near distance wireless communication) and receive music from the portable audio device to output the music through a speaker.

If the driver stores music in the portable audio device, the vehicle sequentially plays the music through the car audio system. Further, the vehicle may sequentially play a music playlist in accordance with a music relation application of the portable audio device through the car audio system. Conventionally, since the driver may listen to the music by directly operating the portable audio device, eyes of the driver are directed to the portable audio device and diverted from the road, thus distracting the driver and deteriorating driving safety.

The above information disclosed in this Background section is only for enhancement of understanding of the background of the disclosure and therefore it may contain information that does not form the related art that is already known in this country to a person of ordinary skill in the art.

### SUMMARY OF THE DISCLOSURE

The present disclosure has been made in an effort to provide a music recommendation system for a vehicle and a method thereof having advantages of recommending music similar to music listened to by a driver by analyzing a physical characteristic of a music file. The present disclosure further provides a music recommendation system of a vehicle which may confirm a physical characteristic of a sound source file mainly listened to among sound source files listened to by the driver, and may extract a sound source file having a physical characteristic similar to the confirmed physical characteristic to provide the extracted sound source file to the driver, and a method thereof.

According to embodiments of the present disclosure, a music recommendation system of a vehicle includes: a sound source analysis unit that analyzes music characteristic information of a plurality of sound source files, respectively, generates a matching table including pieces of music metadata based on the analyzed music characteristic information of the plurality of sound source files, analyzes music characteristic information of a plurality of sound source files, respectively, included in a music list played by a driver of the vehicle, and generates an analysis table based on the analyzed music characteristic information of the plurality of sound source files included in the music list; an input unit that receives a music recommendation request from the driver; and a sound source recommending unit that extracts music characteristic information from the matching table similar to music characteristic information in the analysis table and generates a recommendation list based on the extracted music characteristic information in response to receipt of the music recommendation request.

The sound source recommending unit may identify pieces of music characteristic information in the analysis table, define similar attribute information based on the pieces of music characteristic information, and extract the music characteristic information from the matching table using the defined similar attribute information.

The sound source recommending unit may extract the music characteristic information from the matching table based on physical characteristic information corresponding to the similar attribute information to generate the recommendation list.

The sound source recommending unit may identify the music characteristic information in the analysis table, calculates vector distances with respect to pieces of music characteristic information in the matching table and the music characteristic information in the analysis table, generate a distance value based on the calculated vector distances, and extract the music characteristic information based on the distance value to generate the recommendation list.

The sound source recommending unit may arrange the music characteristic information in an order according to the distance value, extracts music characteristic information according to a preset number and the ordered distance values, and generates the recommendation list based on the extracted music characteristic information.

The music characteristic information may include physical characteristic information including one or more of: a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT.

Furthermore, according to embodiments of the present disclosure, a music recommendation method of a vehicle includes: analyzing music characteristic information of a plurality of sound source files, respectively; generating pieces of music metadata based on the analyzed music characteristic information of the plurality of sound source files; generating a matching table including the pieces of music metadata; analyzing music characteristic information of a plurality of sound source files, respectively, included in a music list played by a driver of the vehicle; generating an analysis table based on the analyzed music characteristic information of the plurality of sound source files included in the music list; receiving a music recommendation request from the driver; extracting music characteristic information from the matching table similar to music characteristic information in the analysis table; and generating a recommendation list based on the extracted music characteristic information in response to receipt of the music recommendation request.

The generating of the recommendation list may include: identifying pieces of music characteristic information in the analysis table; defining similar attribute information based on the pieces of music characteristic information; and extracting the music characteristic information from the matching table using the defined similar attribute information.

The extracting of the music characteristic information from the matching table using the similar attribute information may include: extracting the music characteristic information from the matching table based on physical characteristic information corresponding to the similar attribute information to generate the recommendation list.

The generating of the recommendation list may include: identifying the music characteristic information in the analysis table; calculating vector distances with respect to pieces of music characteristic information in the matching table and the music characteristic information in the analysis table; generating a distance value based on the calculated vector distances; and extracting the music characteristic information based on the distance value to generate the recommendation list.

The extracting of the music characteristic information based on the distance value may include: arranging the music characteristic information in an order according to the distance value; extracting music characteristic information according to a preset number and the ordered distance values; and generating the recommendation list based on the extracted music characteristic information.

The music characteristic information may include physical characteristic information including one or more of: a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT.

Furthermore, according to embodiments of the present disclosure, a music recommendation method of a vehicle includes: analyzing music characteristic information of a plurality of sound source files, respectively; generating pieces of music metadata based on the analyzed music characteristic information of the plurality of sound source files; generating a matching table including the pieces of music metadata; receiving a request sound source file from a driver of the vehicle; analyzing music characteristic information of the request sound source file; extracting music characteristic information from the matching table similar to the music characteristic information of the request sound source file; generating a recommendation list based on the extracted music characteristic information in response to receipt of the request sound source file; and outputting the generated recommendation list.

The generating of the recommendation list may include: calculating vector distances with respect to pieces of music characteristic information in the matching table and the music characteristic information of the request sound source file; generating a distance value based on the calculated vector distances; arranging music characteristic information in an order according to the distance value; extracting music characteristic information according to a preset number and the ordered distance values; and generating the recommendation list based on the extracted music characteristic information

### BRIEF DESCRIPTION OF THE DRAWINGS

FIG. 1 is a block diagram schematically illustrating a music recommendation system of a vehicle according to embodiments of the present disclosure.

FIG. 2 is a flowchart illustrating a music recommendation method for a vehicle according to embodiments of the present disclosure.

FIG. 3 is an exemplary diagram illustrating a method of generating a matching table according to embodiments of the present disclosure.

FIG. 4 is an exemplary diagram illustrating a method of generating an analysis table according to embodiments of the present disclosure.

FIG. 5 is an exemplary diagram illustrating a method of generating a recommendation list according to embodiments of the present disclosure.

FIG. 6 is a flowchart illustrating a music recommendation method for a vehicle according to embodiments of the present disclosure.

### DESCRIPTION OF SYMBOLS

50: music providing device

100: music recommendation system of a vehicle

120: communication unit

130: sound source analyzing unit

140: input unit

150: sound source recommending unit

160: display unit

170: speaker

### DETAILED DESCRIPTION OF THE EMBODIMENTS

Hereinafter, embodiments of the present disclosure will be described with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit. Similarly, one or more of the “units” described below may include at least one control unit installed therein. The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

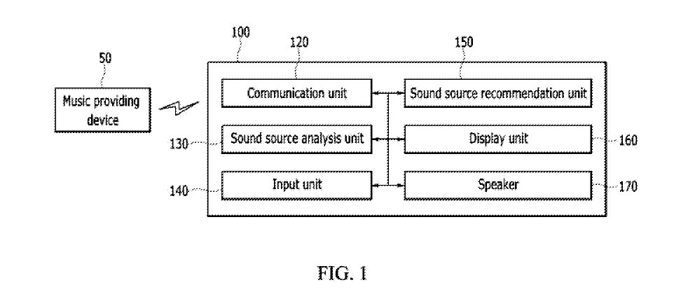

Referring now to the disclosed embodiments, FIG. 1 is a block diagram schematically illustrating a music recommendation system of a vehicle according to embodiments of the present disclosure.

As shown in FIG. 1, the music recommendation system 100 for a vehicle includes a communication unit 120, a sound source analyzing unit 130, an input unit 140, a sound source recommending unit 150, a display unit 160, and a speaker 170.

The communication unit 120 accesses a music providing device 50 to receive a plurality of sound source files from the music providing device 50. Further, the communication unit 120 may receive a music list created by a driver from the music providing device 50. In this case, the music list includes sound source identification (ID) information and sound source basic information matching with the sound source identification information. The sound source identification information is information capable of identifying a sound source file, and the sound source basic information may include at least one of a title of music, a genre, album information, and lyrics. The album information represents information on an album including sound files, and may include an album issue date, a title of an album, and title music of the album.

In this case, the music providing device 50 represents a device to provide the sound file to the sound recommendation system 100 of the vehicle. For example, the driver uses the music providing device 50, and the music providing device 50 may include one of a mobile communication terminal, an MP3 player, a PDA, and a tablet PC which may play the sound source file. Further, the music providing device 50 may be a device to provide sound source streaming such as MelOn or Bugs, or a download service.

The sound source analyzing unit 130 analyzes music characteristic information of the sound source file. In detail, the sound source analyzing unit 130 analyzes music characteristic information with respect to a plurality of sound source files to store the analyzed music characteristic information in music metadata, and generates a matching table including pieces of music metadata.

In this case, the music characteristic information includes at least one of physical characteristic information. That is, the music characteristic information may include physical characteristic information which is one of a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT.

The sound source analyzing unit 130 analyzes music characteristic information on a plurality of sound source files included in the music list created by the driver to generate an analysis table. In this case, music characteristic information matching with sound source identification information is stored in the analysis table.

The input unit 140 is a user interface to receive various data from the driver, and an implementation scheme thereof is not specifically limited thereto. For example, the input unit 140 may receive a predetermined character (or number or specific sign) from the driver through a key pad displayed through the display unit 160 or a separately formed key pad.

The input unit 140 may receive a music recommendation request from the driver. Further, if the driver selects at least one from a plurality of sound source files displayed on the display unit 160 in order to create a music list, the input unit 140 recognizes a selected sound source file, and provides a sound source file selected by the driver to the sound source analysis unit 130.

The sound source recommending unit 150 generates a recommendation list to be provided to the driver. In detail, the sound source recommending unit 150 extracts music characteristic information similar to music characteristic information included in an analysis table from a matching table to generate a recommendation list.

Further, the sound source recommending unit 150 confirms (i.e., identifies) the music characteristic information included in the analysis table, and calculates vector distances with respect to a plurality of pieces of music characteristic information included in the matching table and music characteristic information included in the analysis table to generate a distance value. In addition, the sound source recommendation unit 150 may extract music characteristic information based on the distance value to generate the recommendation list.

The display unit 160 may display operation information generated during an operation of the music recommendation system 100 of the vehicle and result information generated from constituent elements of the music recommendation system 100 of the vehicle. For example, the display unit 160 may display the music list created by the driver and the recommendation list generated from the sound source recommending unit 150. In addition, the display unit 160 may display a plurality of sound source files that allows the driver to create the music list.

The speaker 170 outputs the sound source file. That is, the speaker 170 outputs a plurality of sound source files included in the music list to the driver according to a request. Further, the speaker 170 outputs at least one sound source file included in the recommendation list generated from the music recommending unit.

Since respective constituent elements of the music recommendation system of a vehicle according to embodiments of the present disclosure described referring to FIG. 1 may be integrated or subdivided, the present disclosure is not limited to a corresponding name, but constituent elements for performing the above function may clearly become a configuration of the music recommendation system 100 according to embodiments of the present disclosure.

Hereinafter, the music recommendation method of the vehicle according to embodiments of the present disclosure will be described while focusing on a subject of each step which is the music recommendation system 100 of the vehicle instead of corresponding constituent elements.

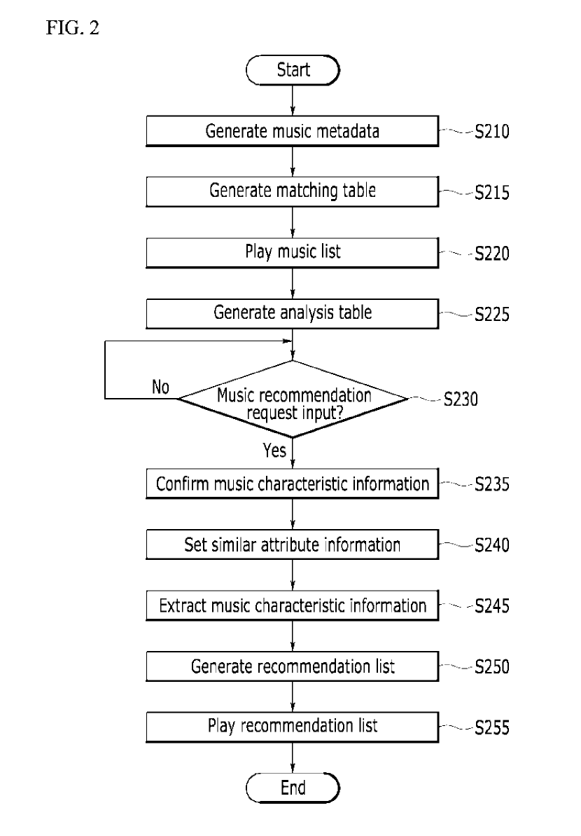

FIG. 2 is a flowchart illustrating a music recommendation method for a vehicle according to embodiments of the present disclosure.

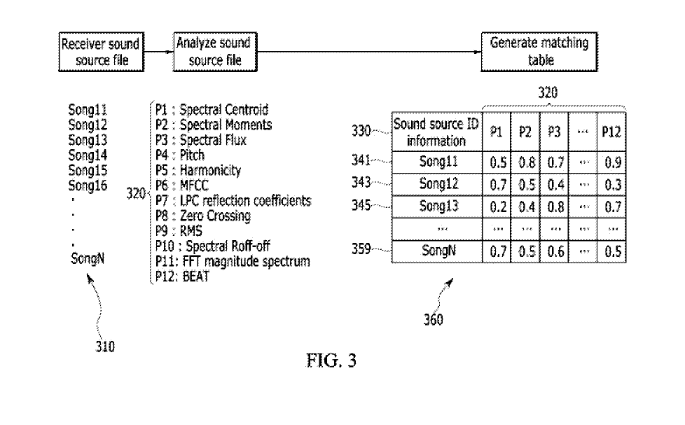

A music recommendation system 100 of the vehicle analyzes a plurality of sound source files to generate music metadata (S210). In other words, the music recommendation system 100 of the vehicle may receive a plurality of sound source files 310 (e.g., as shown in FIG. 3) from the music providing device 50 to analyze music characteristic information 320 including 12 pieces of physical characteristic information with respect to the plurality of sound source files. As shown in FIG. 3, the 12 pieces of physical characteristic information may include physical characteristic information which is one of a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT. Further, as shown in FIG. 3, the music recommendation system 100 of the vehicle matches the analyzed music characteristic information 320 with sound source identification information 330 to generate music metadata 341, 343, 345, . . . , and 359.

The music recommendation system 100 of the vehicle generates a matching table including pieces of music metadata (S215). That is, as shown in FIG. 3, the music recommendation system 100 of the vehicle generates a matching table 360 including pieces of music metadata 341, 343, 345, . . . , and 359.

The music recommendation system 100 of the vehicle plays a music list created by the driver, and including at least one sound source file (S220).

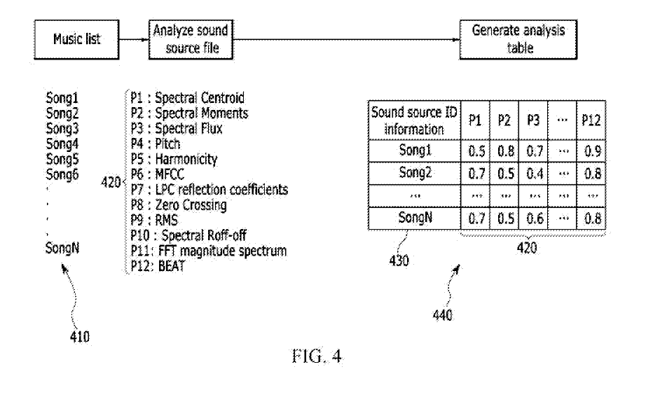

Then, the music recommendation system 100 of the vehicle analyzes the sound source files included in the music list to generate an analysis table (S225). In other words, as shown in FIG. 4, the music recommendation system 100 of the vehicle confirms a music list 410 including a plurality of sound source files to analyze music characteristic information 420 including 12 pieces of physical characteristic information with respect to the plurality of sound source files included in the music list. Further, the music recommendation system 100 of the vehicle matches the music characteristic information 420 with sound source identification information 430 to generate an analysis table 440.

The music recommendation system 100 of the vehicle determines whether the driver inputs a music recommendation request (S230). When the driver does not input the music recommendation request, the routine returns to step S230 so that the music recommendation system 100 of the vehicle may determine whether the driver inputs a music recommendation request.

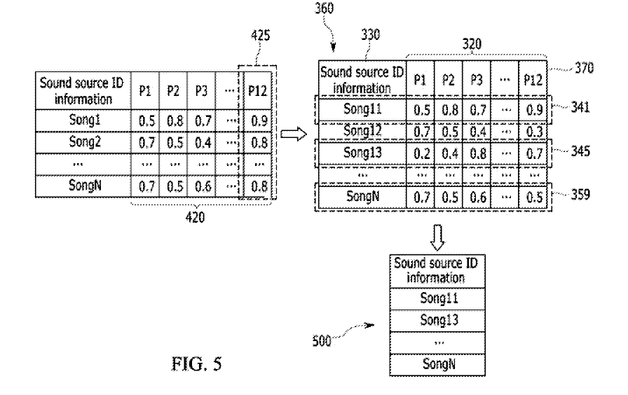

When the driver inputs the music recommendation request, the music recommendation system 100 of the vehicle confirms (i.e., identifies) music characteristic information of the sound source file included in the analysis table (S235). That is, as shown in FIG. 5, the music recommendation system 100 of the vehicle confirms music characteristic information with respect to a plurality of sound source files included in the analysis table.

The music recommendation system 100 of the vehicle defines similar attribute information based on a plurality of pieces of music characteristic information (S240). In other words, the music recommendation system 100 of the vehicle extracts the most representative physical characteristic information preferred by the driver among sound source files listened to by the driver to define the extracted physical characteristic information as the similar attribute information. For example, the music recommendation system 100 of the vehicle may extract physical characteristic information with a majority or greater of sound source files of a total number of sound source files included in the analysis table being greater than a preset value among 12 pieces of physical characteristic information included in a plurality of pieces of music characteristic information. In this case, the preset value may represent a reference value to define the similar attribute information.

The music recommendation system 100 of the vehicle may define the extracted physical characteristic as the similar attribute information. That is, as shown in FIG. 5, the music recommendation system 100 of the vehicle may define a bit which is 12th piece of physical characteristic information 425 corresponding to a value of physical characteristic information being equal to or greater than the preset value and the number thereof being a majority or greater among 12 pieces of physical characteristic information included in the music characteristic information 420 as the similar attribute information. Accordingly, the music recommendation system 100 of the vehicle may determine that the driver likes a sound source file with a high bit.

Meanwhile, the music recommendation system 100 of the vehicle may extract physical characteristic information with a majority or greater of sound source files being less than a preset value among a plurality of pieces of physical characteristic information included in a plurality of pieces of music characteristic information. For example, the music recommendation system 100 of the vehicle may extract physical characteristic information corresponding to a bit included in music characteristic information when a majority or greater of the physical characteristic information corresponding to the bit is less than a preset value. Accordingly, the music recommendation system 100 of the vehicle may determine that the driver likes a sound source file with a low bit.

The music recommendation system 100 of the vehicle extracts music characteristic information from the matching table using similar attribute information defined in step S240 (S245). For example, as shown in FIG. 5, the music recommendation system 100 of the vehicle may extract music metadata 341, 345, . . . , and 359 including music characteristic information of greater than a reference value among physical characteristic information 370 corresponding to a bit from the matching table 300. In this case, the reference value may represent a reference value in order to extract music characteristic information according to similar attribute information.

The music recommendation system 100 of the vehicle generates a recommendation list based on a plurality of pieces of music characteristic information extracted in step S245 (S250). That is, as shown in FIG. 5, the music recommendation system 100 of the vehicle may generate the recommendation list 500 using the extracted music meta-data 341, 345, and 359. In this case, the recommendation list 500 may include sound source identification information.

Finally, the music recommendation system 100 of the vehicle plays the recommendation list generated in step S250 (S255).

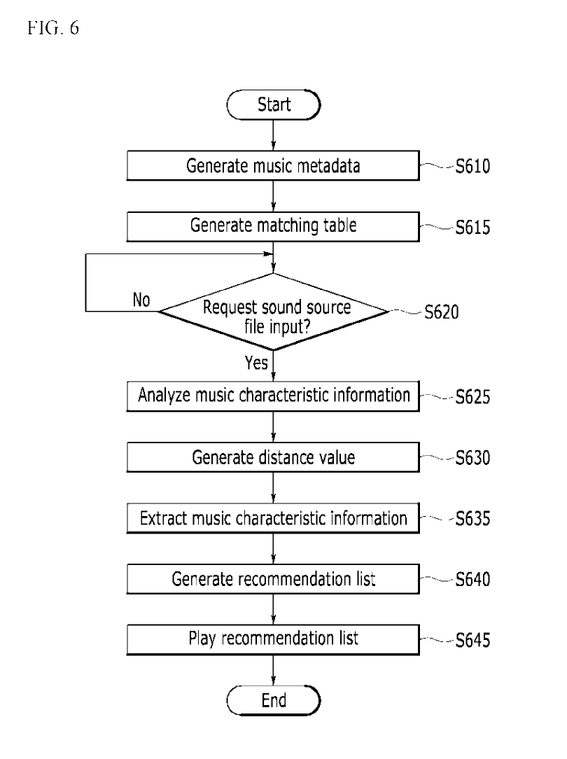

FIG. 6 is a flowchart illustrating a music recommendation method for a vehicle according to embodiments of the present disclosure.

As shown in FIG. 6, the music recommendation system 100 of the vehicle analyzes music characteristic information with respect to a plurality of sound source files to generate music metadata including music characteristic information (S610).

The music recommendation system 100 of the vehicle generates matching data including music metadata generated in step S610 (S615).

The music recommendation system 100 of the vehicle determines whether the driver inputs a request sound source file (S620). That is, if the driver inputs a sound source file for the purpose of being recommended in the music recommendation system 100 of the vehicle, the music recommendation system 100 of the vehicle may receive a recommendation of at least one sound source file having music characteristic information similar to the sound source file. When the driver does not input the request sound source file, the routine returns to step S620 so that the music recommendation system 100 of the vehicle determines whether the driver input a request sound source file.

The music recommendation system 100 of the vehicle analyzes music characteristic information with respect to a sound source file input in step S620 (S625).

The music recommendation system 100 of the vehicle calculates vector distances with respect to music characteristic information with respect to a request sound source file and music characteristic information included in the matching table, respectively, to generate a distance value (S630).

The music recommendation system 100 of the vehicle extracts music characteristic information based on the distance value generated in step S620 (S635). That is, the music recommendation system 100 of the vehicle may arrange music characteristic information in an order according to the distance value. More specifically, the music recommendation system 100 may arrange the music characteristic information in a higher order of distance value based on the distance value, and extract music characteristic information by a preset number. In this case, the preset number represents the number of sound source files to be included in a recommendation list, and may be defined by the driver, or may be defined by a manager to manage the music recommendation system 100 of the vehicle.

The music recommendation system 100 of the vehicle generates a recommendation list based on music characteristic information extracted in step S635 (S640). That is, the music recommendation system 100 of the vehicle may extract sound source information matching with sound characteristic information extracted from the matching table to generate a recommendation list including the extracted sound source identification information.

The music recommendation system 100 of the vehicle plays and provides the recommendation list to the driver (S645).

Accordingly, since embodiments of the present disclosure identifies a physical characteristic of one mainly listened to from sound source files listened to by the driver and extracts a sound source file including a physical characteristic similar to the identified physical characteristic to provide the extracted sound source file to the driver, the driver may listen to a desired sound source file of the driver. Further, since the driver may listen to music without separately operating a portable audio device while driving, the driver may stably drive the vehicle.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A music recommendation system of a vehicle, the system comprising:
a sound source analysis unit that analyzes music characteristic information of a plurality of sound source files, respectively, generates a matching table including pieces of music metadata based on the analyzed music characteristic information of the plurality of sound source files, analyzes music characteristic information of a plurality of sound source files, respectively, included in a music list played by a driver of the vehicle, and generates an analysis table based on the analyzed music characteristic information of the plurality of sound source files included in the music list;
an input unit that receives a music recommendation request from the driver; and
a sound source recommending unit that extracts music characteristic information from the matching table similar to music characteristic information in the analysis table and generates a recommendation list based on the extracted music characteristic information in response to receipt of the music recommendation request.

2. The music recommendation system of a vehicle of claim 1, wherein the sound source recommending unit identifies pieces of music characteristic information in the analysis table, defines similar attribute information based on the pieces of music characteristic information, and extracts the music characteristic information from the matching table using the defined similar attribute information.

3. The music recommendation system of a vehicle of claim 2, wherein the sound source recommending unit extracts the music characteristic information from the matching table based on physical characteristic information corresponding to the similar attribute information to generate the recommendation list.

4. The music recommendation system of a vehicle of claim 1, wherein the sound source recommending unit identifies the music characteristic information in the analysis table, calculates vector distances with respect to pieces of music characteristic information in the matching table and the music characteristic information in the analysis table, generates a distance value based on the calculated vector distances, and extracts the music characteristic information based on the distance value to generate the recommendation list.

5. The music recommendation system of a vehicle of claim 4, wherein the sound source recommending unit arranges the music characteristic information in an order according to the distance value, extracts music characteristic information according to a preset number and the ordered distance values, and generates the recommendation list based on the extracted music characteristic information.

6. The music recommendation system of a vehicle of claim 1, wherein the music characteristic information includes physical characteristic information including one or more of: a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT.

7. A music recommendation method of a vehicle comprising:
analyzing music characteristic information of a plurality of sound source files, respectively;
generating pieces of music metadata based on the analyzed music characteristic information of the plurality of sound source files;
generating a matching table including the pieces of music metadata;
analyzing music characteristic information of a plurality of sound source files, respectively, included in a music list played by a driver of the vehicle;
generating an analysis table based on the analyzed music characteristic information of the plurality of sound source files included in the music list;
receiving a music recommendation request from the driver;
extracting music characteristic information from the matching table similar to music characteristic information in the analysis table; and
generating a recommendation list based on the extracted music characteristic information in response to receipt of the music recommendation request.

8. The music recommendation method of a vehicle of claim 7, wherein the generating of the recommendation list comprises:
identifying pieces of music characteristic information in the analysis table;
defining similar attribute information based on the pieces of music characteristic information; and
extracting the music characteristic information from the matching table using the defined similar attribute information.

9. The music recommendation method of a vehicle of claim 8, wherein the extracting of the music characteristic information from the matching table using the similar attribute information comprises:
extracting the music characteristic information from the matching table based on physical characteristic information corresponding to the similar attribute information to generate the recommendation list.

10. The music recommendation method of a vehicle of claim 7, wherein the generating of the recommendation list comprises:
identifying the music characteristic information in the analysis table;
calculating vector distances with respect to pieces of music characteristic information in the matching table and the music characteristic information in the analysis table;
generating a distance value based on the calculated vector distances; and
extracting the music characteristic information based on the distance value to generate the recommendation list.

11. The music recommendation method of a vehicle of claim 10, wherein the extracting of the music characteristic information based on the distance value comprises:
arranging the music characteristic information in an order according to the distance value;
extracting music characteristic information according to a preset number and the ordered distance values; and
generating the recommendation list based on the extracted music characteristic information.

12. The music recommendation method of a vehicle of claim 7, wherein the music characteristic information includes physical characteristic information including one or more of: a spectral centroid, spectral moments, a spectral flux, a pitch, harmonicity, mel-frequency cepstral coefficients (MFCC), linear prediction reflection coefficients, zero crossing, root mean square (RMS), spectral roll-off, a fast Fourier Transform magnitude spectrum, and BEAT.

13. A music recommendation method of a vehicle, comprising:
analyzing music characteristic information of a plurality of sound source files, respectively;
generating pieces of music metadata based on the analyzed music characteristic information of the plurality of sound source files;
generating a matching table including the pieces of music metadata;
receiving a request sound source file from a driver of the vehicle;
analyzing music characteristic information of the request sound source file;
extracting music characteristic information from the matching table similar to the music characteristic information of the request sound source file;
generating a recommendation list based on the extracted music characteristic information in response to receipt of the request sound source file; and
outputting the generated recommendation list.

14. The music recommendation method of a vehicle of claim 13, wherein the generating of the recommendation list comprises:
calculating vector distances with respect to pieces of music characteristic information in the matching table and the music characteristic information of the request sound source file;
generating a distance value based on the calculated vector distances;
arranging music characteristic information in an order according to the distance value;
extracting music characteristic information according to a preset number and the ordered distance values; and
generating the recommendation list based on the extracted music characteristic information.
